(19) United States
(12) Patent Application Publication
(10) Pub. No.: US 2010/0147010 A1
(43) Pub. Date: Jun. 17, 2010

(54) HEAT EXCHANGER DEVICE FOR TREATING LIQUID FOOD MIXTURES

(75) Inventors: Genesio Bravo, Alte Ceccato-Vicenza (IT); Stefano Bravo, Sovizzo-Vicenza (IT)

Correspondence Address: HEDMAN & COSTIGAN P.C., 1185 AVENUE OF THE AMERICAS, NEW YORK, NY, 10036, US

(73) Assignee: G.S.G. S.r.l., Vicenza (IT)

(21) Appl. No.: 12/733,144

(22) PCT Filed: Aug. 29, 2007
(86) PCT No.: PCT/IB2007/002522

§ 371 Date: Feb. 9, 2010

(51) Int. Cl. A23G 9/12

(52) U.S. Cl. 62/342

(57) ABSTRACT

A heat exchanger device for treating liquid food mixtures comprises a cylindrical chamber (31), heat exchange means (32) and a cylindrical rotor (33) having an outer diameter substantially equal to the inner diameter of said cylindrical chamber (31). According to the invention, said rotor (33) carries a helical recess or groove (34) on the outer surface.

The present invention refers to a heat exchanger device for treating liquid food mixtures, in particular for producing ice cream.

Machines for producing so-called soft ice cream, as well as machines for producing semi-industrial ice cream, need cooling and/or heating treatments to be carried out on a liquid food mixture, preferably carried out quickly and on small amounts of liquids.

The exchanger object of the present invention is particularly applicable in machines for producing so-called soft ice cream, like for example that of the co-pending patent application filed in the name of Bravo S.p.A on the same date with the title “Apparatus for producing so-called soft ice cream and process for feeding a relative mixture”. In such an apparatus the exchanger is used to rapidly cool down a liquid mixture at the end of the pasteurisation process.

Moreover, the exchanger object of the present invention could also be applicable for heating a liquid mixture in homogenising machines for producing semi-industrial ice cream or other.

Exchangers with plates or with concentric tubes, of the known type, have numerous technical drawbacks linked to a substantial complexity of construction, which makes them difficult to inspect and clean. Moreover, if used as coolers, they have substantial problems relative to the formation of ice that risks to block the flow of liquids.

Other known exchangers, like those provided with a bladed mixer, whilst being constructively simple and easy to clean, are too slow due to the mixing and the thermal inertia of the liquid.

The general purpose of the present invention is to make a heat exchanger device for treating liquid food mixtures with high yield, which is extremely simple, cost-effective and particularly functional.

Another purpose is to make a heat exchanger device for treating liquid food mixtures suitable for operation with small flow rates or else with low powers, these two being inversely proportional to each other.

In view of the aforementioned purposes, according to the present invention, it has been thought of to make a heat exchanger device for treating liquid food mixtures, having the characteristics outlined in the attached claims.

The structural and functional characteristics of the present invention and its advantages compared to the prior art shall become clearer from an examination of the following description, referring to the attached drawings, which show a heat exchanger device for treating liquid food mixtures made according to the innovative principles of the invention itself.

In the drawings:

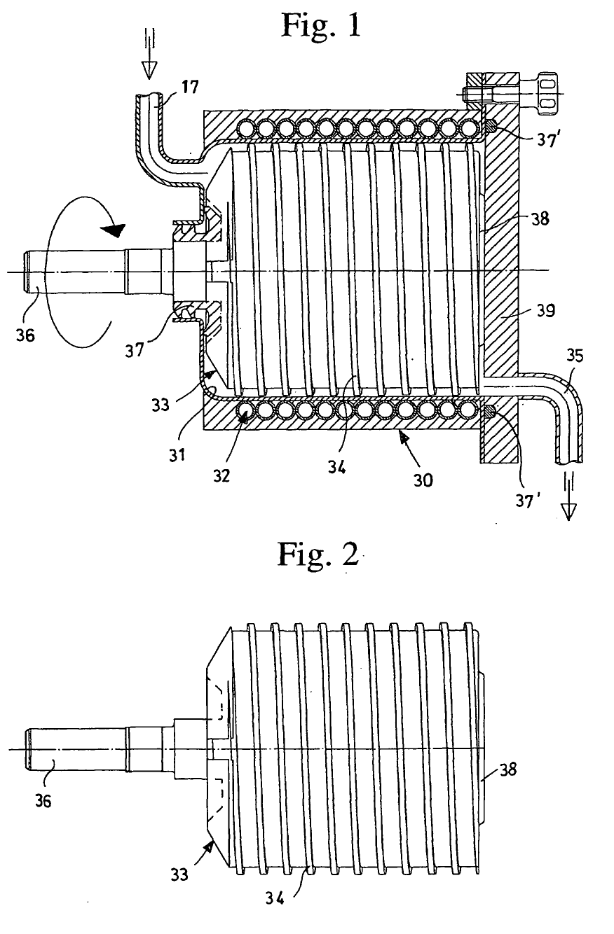

FIG. 1 shows, partially in section, a heat exchanger device for treating liquid food mixtures object of the present invention;

FIG. 2 shows the rotor of FIG. 1.

With reference to FIG. 1, a heat exchanger device for treating liquid food mixtures in object is wholly indicated with 30, and in the illustrated example, according to the present invention, comprises a cylindrical chamber 31 surrounded by heat exchange means 32 and a cylindrical rotor 33 having outer diameter substantially equal to the inner diameter of the cylindrical chamber 31 and carrying a helical recess or groove 34 on the outer surface.

The helical recess 34 of the rotor 33, as shown in the detail of FIG. 2, at each point has a rectangular section to make, in coupling with the cylindrical chamber 31, a spiral of liquid of rectangular section, in which one of the two longer sides is in direct contact with the wall of the cylindrical chamber 31 for the heat exchange.

The helical recess 34 can, for example, be turned like a helix with short pitch on a bronze cylinder, suitable for use with food, or another compatible material, made as a hollow or full cylinder, according to requirements.

The selection of the size of the recess 34 depends upon the desired flow rate as well as the rotation speed of the rotor 33 so as to avoid a phenomenon of channelling hydraulic motion, in which there is only a part of the rotor 33 filled with liquid and the remaining part with air.

The length and the diameter of the rotor 33, on the other hand, are selected based upon the power that one wishes to dispense, these two variables being directly connected with the exchange surface.

The rotor 33 comprises a drive shaft 36 at one end, provided with an O-ring 37 that makes a rotary seal on the cylindrical chamber 31.

At the opposite end the rotor 33 comprises an abutment surface 38 against a closing flange 39 of the cylindrical chamber 31, which make the seal through gaskets 37′.

The inlet and outlet of the liquid mixture into/from the heat exchanger device 30, object of the present invention, in the non-limiting example embodiment shown in FIG. 1, respectively take place through an inlet duct 17 arranged at a first end of the cylindrical chamber 31, and in particular on top of it and through a second outlet duct 35 arranged at the opposite end in a base portion of the cylindrical chamber 31.

The fluid food mixture entered into the heat exchanger device 30 through the first duct 17, circulates in the gap that forms between the rotor 33 and the cylindrical chamber 31, where the heat exchange takes place. In the helical groove 34 the fluid takes on a spiral-shaped configuration with rectangular section, distinguished by a large heat exchange surface.

According to a first embodiment, the heat exchanger device 30, object of the present invention, is used as a cooler in a machine for producing soft ice cream to cool down the liquid mixture for example from a temperature of about +85° C. to a temperature of about +4° C. The heat exchange means 32 consist of an evaporator comprising a coil for a refrigerant, surrounded by an insulating outer wall, as shown in FIG. 1.

The fluid spiral is placed in direct contact with the evaporator 32, the surface temperature of which is slightly above the freezing temperature of the treated liquid. This is to avoid the formation of ice in the recess 34 of the rotor 33.

In any case, the rotary motion of the rotor 33 advantageously pushes the frozen liquid towards the outlet 35, fracturing the possible ice that has formed.

To work as a heater, the heat exchanger device object of the present invention can comprise electrical resistances, not shown, such as heat exchange means. Alternatively, the heat exchange means for heating the liquid mixture can consist of the coil shown in FIG. 1 in which the heating fluid is circulated.

The heat exchanger device for treating liquid food mixtures, object of the present finding, advantageously allows the total volume to be reduced whilst maintaining a large exchange surface.

From what has been described above with reference to the figures, it is clear how a heat exchanger device for treating liquid food mixtures according to the invention is particularly useful and advantageous. The purpose mentioned in the preamble of the description is thus achieved.

Of course, the shapes of the heat exchanger device for treating liquid food mixtures can be different from the one shown as a non-limiting example in the drawings, just as the materials can also be different.

The scope of protection of the invention is therefore defined by the attached claims.

1. Heat exchanger device for treating liquid food mixtures characterised in that it comprises a cylindrical chamber (31), heat exchange means (32) and a cylindrical rotor (33) having an outer diameter substantially equal to the inner diameter of said cylindrical chamber (31), in which said rotor (33) carries a helical recess or groove (34) on the outer surface.

2. Device according to claim 1, characterised in that said helical recess (34) has a rectangular section.

3. Device according to claim 1, characterised in that said heat exchange means (32) comprise a coil for a refrigerant.

4. Device according to claim 3, characterised in that said rotor (33) is made from bronze.

5. Device according to claim 1, characterised in that said rotor (33) at one end comprises a drive shaft (36) and at an opposite end comprises an abutment surface (38) next to a closing flange (39) of said cylindrical chamber (31).

6. Device according to claim 1, characterised in that it comprises an inlet duct (17) arranged at a first end of said cylindrical chamber (31), and in particular on the top thereof, as well as a second outlet duct (35) arranged at the opposite end of said cylindrical chamber (31) in a base portion.
